(19) United States
(12) Patent Application Publication
(10) Pub. No.: US 2006/0245304 A1
(43) Pub. Date: Nov. 2, 2006

(54) Timepiece driving apparatus and time calculating apparatus

(75) Inventors: Akihiko Maruyama, Suwa-shi (JP); Joji Kitahara, Shioriji-shi (JP); Akihiro Sawada, Matsumoto-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/476,060

(22) Filed: Jun. 28, 2006

Related U.S. Application Data
(62) Division of application No. 10/780,903, filed on Feb. 19, 2004.

(30) Foreign Application Priority Data
Feb. 21, 2003 (JP) JP2003-044341
Mar. 31, 2003 (JP) JP2003-094255

(51) Int. Cl. G04B 1/00

(52) U.S. Cl. 368/204

(57) ABSTRACT

A timing device having a generator unit, a storage unit, and a drive unit is provided. The generator unit has a generating coil and converts kinetic energy into electric energy by utilizing electromagnetic induction. The storage unit stores the electric energy. The drive unit has a piezoelectric actuator, a mechanical structure, and a time display unit. The piezoelectric actuator is supplied with the electric energy from the storage unit and is caused to oscillate according to signals from the communication unit. The mechanical structure is provided with a time display unit and is driven by the piezoelectric actuator.

### CROSS-REFERENCE TO RELATED APPLICATIONS

This application is a divisional application of U.S. patent application Ser. No. 10/780,903 filed on Feb. 19, 2004, which claims priority to Japanese Patent Application Nos. JP2003-044341 and 2003-094255 filed on Feb. 21, 2003 and Mar. 31, 2003 respectively. The entire disclosures of U.S. patent application Ser. No. 10/780,903 and Japanese Patent Application Nos. JP2003-044341 and 2003-094255 are hereby incorporated herein by reference.

### BACKGROUND OF THE INVENTION

1. Field of the Invention

The present invention relates to a timing device, and particularly relates to a timepiece and a radio-controlled timepiece equipped with a generating device that utilizes electromagnetic induction.

2. Background Information

Timepieces with electromagnetic generators that are equipped with a power generator having a generating coil, and that generate electricity with electromagnetic induction and store the generated electrical power to be used as a driving power source, are currently being commercialized (for example, see Japanese Patent No. 2000-147167).

The conventional timepieces with electromagnetic generators described above have a large leakage field when the electric motor generates electricity, the leakage field has no small effect on the electromagnetic motor for the timepiece, and it is possible that the timepiece may stop due to the leakage field and the displayed time will be slowed.

Also known in conventional practice are radio-controlled timepieces wherein an LF standard wave (JG2AS) is received from the outside at a specific cycle and the displayed time of the electromagnetic correction timepiece is corrected based on time data superposed on this LF standard wave (JG2AS).

The time data included in the LF standard wave used to correct the displayed time of a radio-controlled timepiece have 60 seconds in one cycle (=one piece of data). This time data include the total number of days from the first day of the first month of the current year, the current hour, the current minutes, and other such data.

However, in conventional radio-controlled timepieces, when electromagnetic noise is generated by a stepping motor for driving the time-displaying pointers when an LF standard wave is received by a receiving antenna, the time data included in the LF standard wave can no longer be correctly received, and reception may be impossible or incorrect.

To resolve these problems, the technique in Japanese Patent No. 3163403 employs a configuration in which a circuit is provided for stopping the stepping motor while the LF standard wave is received, the generation of electromagnetic noise originating in the driving of the stepping motor is prevented, and the current time is corrected after the LF standard wave is received.

Therefore, the radio-controlled timepiece described in Japanese Patent No. 3163403 has had drawbacks in that the circuit configuration is complicated and the time cannot be correctly displayed while the LF standard wave is received.

It will be clear to those skilled in the art from the disclosure of the present invention that an improved timepiece is necessary because of the above-mentioned considerations. The present invention meets the requirements of these conventional technologies as well as other requirements, which will be apparent to those skilled in the art from the disclosure hereinbelow.

### SUMMARY OF THE INVENTION

A drive device relating to the present invention includes a generator unit, a storage unit, and a drive unit. The generator unit has a generating coil, and converts kinetic energy into electric energy by utilizing electromagnetic induction. The storage unit stores the electric energy. The drive unit has a piezoelectric actuator and a mechanical structure. The piezoelectric actuator is supplied with the electric energy from the storage unit. The mechanical structure is driven by means of the piezoelectric actuator.

The timing device relating to the present invention includes an antenna, a communication unit, and a drive unit. The communication unit communicates with an external communication device via the antenna. The drive unit has a piezoelectric actuator and a mechanical structure. The mechanical structure has a time display unit for displaying time information. The piezoelectric actuator vibrates according to signals from the communication unit. The mechanical structure is driven by means of the piezoelectric actuator, and the time information is displayed on the time display unit.

The objects, characteristics, merits, and other attributes of the present invention described above shall be clear to those skilled in the art from the description of the invention hereinbelow. The description of the invention and the accompanying diagrams disclose the preferred embodiments of the present invention.

### BRIEF DESCRIPTION OF THE DRAWINGS

Referring to the accompanying diagrams, which partially disclose the present invention:

FIG. 1 is a structural block diagram of the timing device relating to the first embodiment;

FIG. 2 is a partial plan view of the timing device relating to the first embodiment;

FIG. 3 is a cross-sectional view of part of the timing device relating to the first embodiment;

FIG. 4 is an explanatory diagram of the structure of a piezoelectric actuator;

FIG. 5 is a side view of a piezoelectric actuator;

FIG. 6 is a plan view of a piezoelectric actuator;

FIG. 7 is an enlarged view of the contact section of a piezoelectric actuator;

FIG. 8 is a cross-sectional view of part of the timing device relating to the second embodiment;

FIG. 9 is a cross-sectional view of part of the timing device relating to the third embodiment;

FIG. 10 is a diagram illustrating the frequency-impedance characteristics of the specific configuration of a piezoelectric actuator;

FIG. 11 is an explanatory diagram of an example of the electrode arrangement of a piezoelectric actuator;

FIG. 12 is an explanatory diagram of the electrode arrangement for another piezoelectric actuator;

FIG. 13 is an explanatory diagram of the arrangement of electrodes in a piezoelectric actuator driven both forwards and backwards;

FIG. 14 is an explanatory diagram of another arrangement of electrodes in a piezoelectric actuator driven both forwards and backwards;

FIG. 15 is a partial plan view of the timing device relating to the fourth embodiment;

FIG. 16 is a cross-sectional view of one part of the timing device relating to the fourth embodiment;

FIG. 17 is a cross-sectional view of another part of the timing device relating to the fourth embodiment; and

FIG. 18 is a cross-sectional view of part of the timing device relating to the fifth embodiment.

### DESCRIPTION OF THE PREFERRED EMBODIMENTS

Embodiments of the present invention will now be described with reference to the drawings. As will be apparent from the disclosure of the present invention to those skilled in the art, the description of the invention embodiments is intended solely to illustrate the present invention and should not be construed as limiting the scope of the present invention, which is defined by the claims described below or by their equivalents.

The preferred embodiments of the present invention will now be described with reference to the drawings.

### [1] First Embodiment

The first embodiment will first be described.

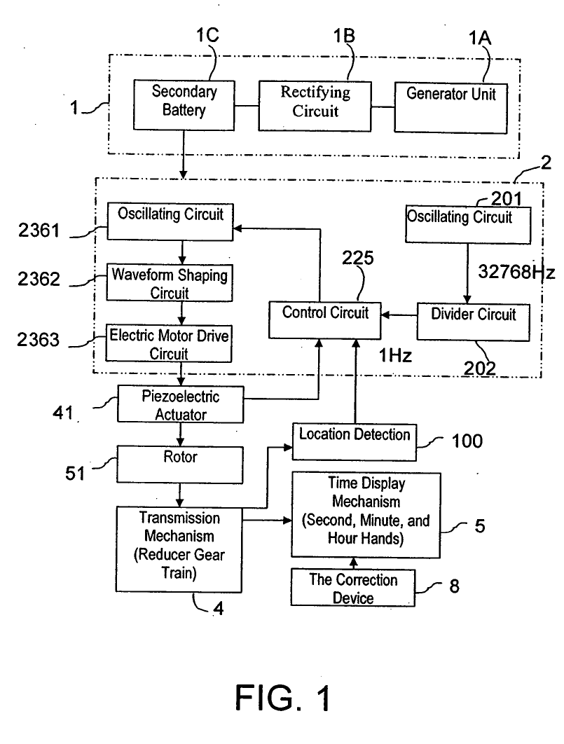

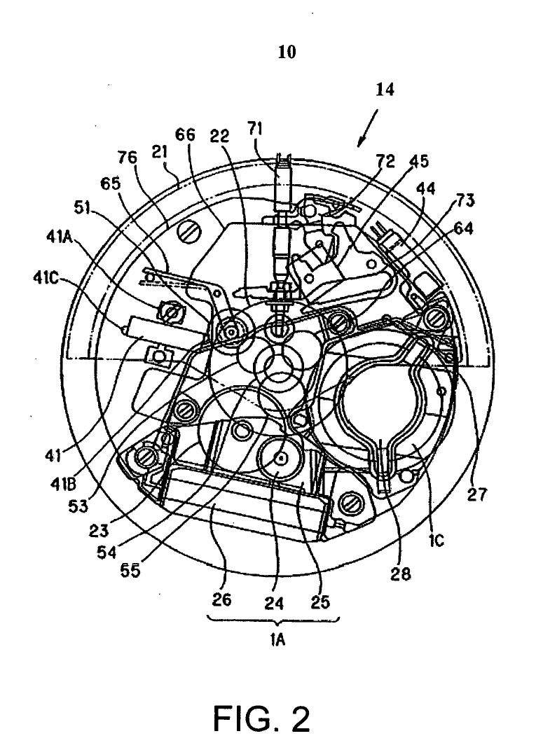

FIG. 1 is a structural block diagram showing an analog electronic timepiece according to the present embodiment. FIG. 2 is a plan view showing the same analog electronic timepiece.

In the timing device of the first embodiment, the object of control for the drive device is a time display mechanism 5, and the time display mechanism 5 is operated by means of a piezoelectric actuator 41 constituting the drive device.

An electric power source 1 has a generating coil and an oscillating weight to be hereinafter described, and includes a generator unit (generating means) 1A for generating electricity by converting the kinetic energy of the oscillating weight to electric energy by electromagnetic induction, a rectifying circuit 1B for rectifying the AC power generated by the generator unit 1A into DC power, and a secondary battery (storage means) 1C for storing the rectified DC power.

In FIG. 1, the electric energy from the electric power source 1 is received and an oscillating circuit 201 of an electronic circuit 2 oscillates at a standard signal, which is 32,768 Hz. The standard signal of 32,768 Hz is converted to 1 Hz in a divider circuit 202. A signal from the divider circuit 202 is sent to a control circuit 225. This control circuit 225 controls the supply timing for the drive pulse of the piezoelectric actuator 41, which is the drive source for the time display mechanism 5. The control circuit 225 then inputs a drive pulse command signal to an oscillating circuit 2361, which sends the drive pulse to the piezoelectric actuator 41.

The drive pulse command signal with controlled supply timing is inputted from the control circuit 225 to the oscillating circuit 2361, and is then inputted to an electric motor drive circuit 2363 via a waveform shaping circuit 2362. This electric motor drive circuit 2363 supplies a drive pulse to the piezoelectric actuator 41. The piezoelectric actuator 41 converts the electric energy into mechanical energy according to the drive pulse, and utilizes the piezoelectric effect to push the external periphery of the driven body (rotor) 51. The rotor 51, rotated by the pushing action of the piezoelectric actuator 41, rotatably drives a transmission mechanism (reduction gear train) 4 and the time display mechanism 5. The display on the time display mechanism 5 is corrected by means of a time correction device 8.

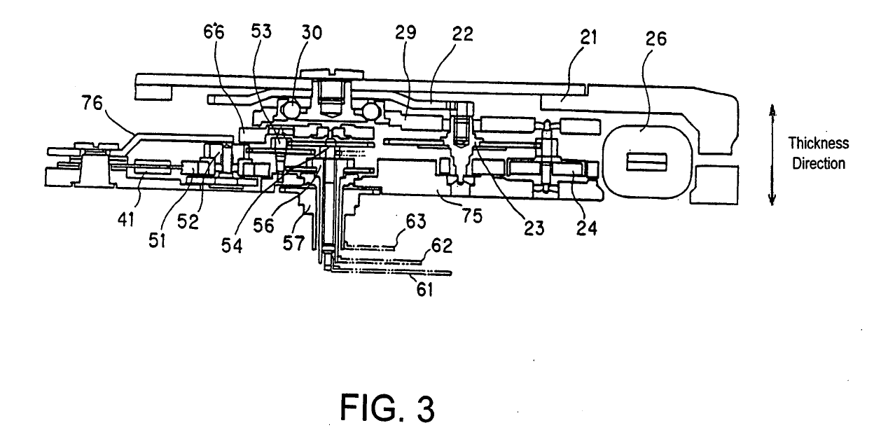

FIG. 2 is a partial plan view of the timing device relating to the first embodiment. FIG. 3 is a cross-sectional view of part of the timing device.

The timing device 10 is a wristwatch designed for use by wrapping a belt coupled with the main body of the device around the wrist of the user.

In general terms, the timing device 10 includes an electric power source 1 (see FIG. 1), and also has a timing unit (drive means) and operating unit 14 to be hereinafter described.

The electric power source 1 of the timing device 10 includes an oscillating weight 21, an oscillating weight wheel 22, a generating rotor intermediate wheel 23, a generating rotor 24, a generating stator 25, a generating coil 26, a secondary battery 1C, a secondary battery positive terminal 27 and secondary battery negative terminal 28 for electrically connecting the secondary battery 1C and a base plate, an oscillating weight support 29, and a bearing 30. The generating rotor 24, generating stator 25, and generating coil 26 constitute the generator unit 1A.

In general terms, the timing unit includes a piezoelectric actuator 41 for driving a second hand as a pointer component, a transmission mechanism (gear train section) 4 for transmitting the driving force for driving the pointer, a crystal oscillator 44 for keeping time, and a timing IC 45 for performing various timing processes on the basis of standard oscillation signals for timing.

The transmission mechanism 4 is similar to a regular analog timepiece and includes a rotor 51, a rotor pinion 52, a fifth wheel and pinion 53, a fourth wheel and pinion 54, a third wheel and pinion 55, a second wheel and pinion 56, an hour wheel 57, a second hand 61, a minute hand 62, an hour hand (hour display means) 63, a minute wheel 64, a rotor press member 65, and a train wheel bridge 66.

The operating unit 14 includes a setting stem 71, a setting lever 72, and a yoke 73, and is designed to be able to perform various settings, including time setting and time correction, similar to other timing devices. The setting stem 71, setting lever 72, and yoke 73 are made from steel materials in order to be more compact.

Furthermore, the timing device 10 includes a main plate 75 and a circuit press plate 76 as structural components.

The relative arrangement of the electromagnetic generator and the piezoelectric actuator will now be described with reference to FIGS. 2 and 3.

In the first embodiment, assuming there is a plane perpendicular to the thickness direction of the timing device 10, the generator unit 1A is disposed at a location in which the positive projection of the generator on this plane does not overlap the positive projection of the piezoelectric actuator 41 on this plane.

Such an arrangement allows the thickness of the timing device 10 to be reduced and makes it possible to configure a thin wristwatch with an electromagnetic generator.

The piezoelectric actuator constituting the drive device will now be described.

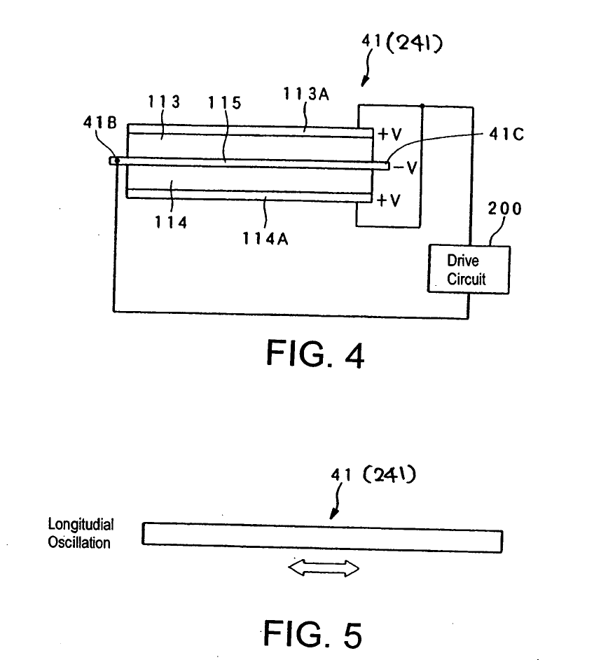

FIG. 4 is an explanatory diagram of the configuration of the piezoelectric actuator.

The piezoelectric actuator 41 is configured with a stainless steel plate or another such reinforcing plate 115 held between two plate-shaped piezoelectric elements 113 and 114, as shown in FIG. 4. A holding section 41A (see FIG. 2), a contact section 41B, and a balance section 41C are formed integrally on the reinforcing plate 115. This layered structure makes it possible to suppress the over-amplitude of the piezoelectric actuator 41 and the damage to the piezoelectric elements 113 and 114 by external forces.

Electrodes 113A and 114A are arranged on top of the piezoelectric elements 113 and 114 as shown in FIG. 4, and the voltage from a drive circuit 200 is supplied to the piezoelectric elements 113 and 114 via these electrodes 113A and 114A.

When the polarization direction of the piezoelectric element 113 and the polarization direction of the piezoelectric element 114 are opposite, the piezoelectric elements 113 and 114 are displaced so as to expand and contract if an alternating-current drive signal is supplied from the drive circuit 200, such that the electric potentials at the top, middle, and bottom in the diagram are +V, −V, and +V (or −V, +V, and −V), respectively.

The +V drive signal and the −V drive signal are alternating-current signals whose phases have been reversed. Therefore, the amplitude of the oscillation created in the piezoelectric element 113 on top of the reinforcing plate 115 and the piezoelectric element 114 on the bottom can be increased compared to when 0 V is applied to the reinforcing plate 115 (when the reinforcing plate 115 is connected to the grounding wire of the drive circuit 200). For the sake of simplicity, the power supply electrode in contact with the piezoelectric elements 113 and 114 is omitted and only the electrodes 113A and 114A positioned on the outer side are shown in FIG. 4.

Lead titanate zirconate, quartz, lithium niobate, barium titanate, lead titanate, lead metaniobate, polyvinylidene fluoride, zinc lead niobate, lead scandium niobate, or the like is used as the piezoelectric elements 113 and 114.

The operation of the piezoelectric actuator 41 will now be described.

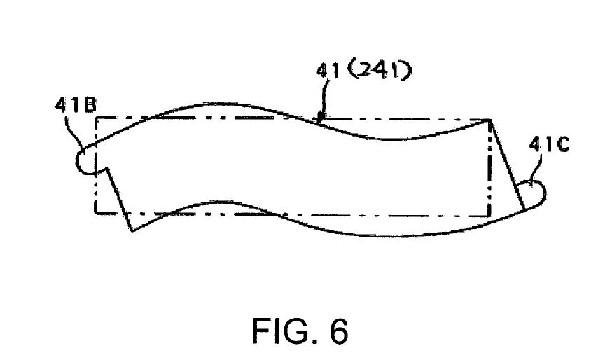

When an alternating-current drive signal is applied to the piezoelectric elements 113 and 114 from the drive circuit 200 via the electrodes 113A and 114A, oscillation that expands and contracts in the longitudinal direction is created in the piezoelectric elements 113 and 114. In this case, the piezoelectric elements 113 and 114 create longitudinal oscillation that expands and contracts in the longitudinal direction, as shown by the arrow in FIG. 5. When the piezoelectric actuator 41 is electrically vibrated by the longitudinal oscillation due to the application of a drive signal to the piezoelectric elements 113 and 114, an angular momentum is created about the center of gravity of the piezoelectric actuator 41 by the unbalanced weight of the piezoelectric actuator 41. This angular momentum induces curved secondary oscillation whereby the piezoelectric actuator 41 swings in the width direction, as shown in FIG. 6. At this point a greater degree of curved oscillation can be induced to create a greater angular momentum by disposing the contact section 41B on the tip of the piezoelectric actuator 41 opposite from the balance section 41C.

Thus, creating longitudinal oscillation and curved oscillation in the piezoelectric actuator 41 and combining these two types of oscillation causes the area at which the contact section 41B of the piezoelectric actuator 41 and the rotor 51 come in contact to move along an elliptic path. As a result of the movement of the contact section 41B along an elliptic path in the direction of the timepiece, the force of the contact section 41B pushing on the rotor 51 increases when the contact section 41B is in a position expanded toward the rotor 51, and the force of the contact section 41B pushing on the rotor 51 decreases when the contact section 41B is expanded to a position distanced from the rotor 51. Therefore, the rotor 51 is rotatably driven in the direction of displacement of the contact section 41B while both types of pressure are large, or, in other words, when the contact section 41B is in a position expanded toward the rotor 51.

As described above, the piezoelectric actuator 41 rotatably drives the rotor 51 by elliptical movement due to both the longitudinal oscillation and the curved oscillation. At this point, the rotor 51 is pressed against the contact section of a second drive actuator by a second rotor pressure member 65, whereby the rotor 51 is rotatably driven in a reliable manner.

The rotational driving of the rotor 51 causes the rotor pinion 52 to rotate and the fifth wheel and pinion 53 interlocking with the rotor pinion 52 to be rotatably driven.

Furthermore, the fifth wheel and pinion 53 interlocks with the fourth wheel and pinion 54, causing the second hand 61 fixed to the fourth wheel and pinion 54 to move.

The third wheel and pinion 55 interlocking with the fourth wheel and pinion 54 is also rotatably driven.

Furthermore, the third wheel and pinion 55 interlocks with the second wheel and pinion 56 and with the minute wheel 64 via the second wheel and pinion 56, and movement is induced in the minute hand 62 fixed to the second wheel and pinion 56 and in the hour hand 63 fixed to the hour wheel 57.

The electric power source 1 includes an oscillating weight 21, an oscillating weight wheel 22, a generating rotor intermediate wheel 23, a generating rotor 24, a generating stator 25, a generating coil 26, a secondary battery 1C, a secondary battery positive terminal 27 and secondary battery negative terminal 28 for electrically connecting the secondary battery 1C and the circuit board, an oscillating weight support 29, and a bearing 30. The generating rotor 24, generating stator 25, and generating coil 26 constitute the generator unit 1A.

The operation of the electric power source 1 will now be described.

When the oscillating weight 21 of the electric power source 1 rotates due to the hand movement of the user with the timing device 10, rotation is induced in the oscillating weight wheel 22 supported by the oscillating weight support 29 via the bearing 30 in a manner that allows integral rotation with the oscillating weight 21.

The oscillating weight wheel 22 interlocks with the generating rotor intermediate wheel 23, causing the generating rotor intermediate wheel 23 to rotate.

Furthermore, the generating rotor intermediate wheel 23 interlocks with the generating rotor 24, and the rotation of the generating rotor 24 within the generating stator 25 creates AC power in the generating coil 26 by electromagnetic induction.

At this point, the AC power generated by the generator unit 1A is rectified into DC power by the rectifying circuit 1B (see FIG. 1) and is stored in the secondary battery 1C. The CD power stored in the secondary battery 1C is then supplied to all the circuits via the secondary battery positive terminal 27 and the secondary battery negative terminal 28. In the first embodiment the secondary battery 1C is preferably disposed so as not to overlap with the piezoelectric actuator 41 or the generator unit 1A within an imaginary plane perpendicular to the thickness direction of the timing device 10.

Also, the operating unit 14 is preferably disposed so as not to overlap with the timing IC 45 within the imaginary plane perpendicular to the thickness direction of the timing device 10. Furthermore, the setting stem 71, setting lever 72, and yoke 73 constituting the operating unit 14 are made from steel materials, and therefore are preferably disposed at a position facing the generator unit 1A across the transmission mechanism 4 so as not to create magnetism.

In the first embodiment, the electromagnetic noise resulting from the power generation of the electromagnetic generator has no effect because a piezoelectric actuator is used to drive the pointers. Therefore, the driving of the pointers does not stop and the displayed time is not slowed. Even if the generating coil has a high magnetic field, the time display is not affected thereby, and the time is accurately displayed. Also, power can be generated efficiently even if the magnetic field of the generating coil is set high, because the electromagnetic step motor does not change the magnetic flow during power generation.

Also, the piezoelectric actuator and the generator unit (electromagnetic generator) can be disposed roughly in the same plane and the piezoelectric actuator for driving the pointers can be disposed near the generator unit, so the timing device, the driving device, and the like can be reduced in size and thickness. Improved magnetic resistance to prevent malfunctions in the electromagnetic step motor must be provided in order to be able to dispose the electromagnetic step motor nearby while improving the power generating properties of the generator unit 1A, and to accomplish this, it is necessary to increase the number of turns in the coil of the electromagnetic step motor. As a result, it is possible to improve the magnetic resistance of the electronic timepiece and to obtain a drive that requires less energy because of an increase in the coil resistance of the electromagnetic step motor. However, the outer shape of the coil of the electromagnetic step motor becomes wider, so the thickness thereof cannot be increased to near the center of rotation of the oscillating weight, which results in hindering the improvement of the power generating properties. Accordingly, in the first embodiment, assuming there is a plane perpendicular to the thickness direction of the timing device 10, the generator unit 1A is disposed at a location in which the positive projection of the generator on this plane does not overlap the positive projection of the piezoelectric actuator 41 on this plane, and therefore it is possible to improve the power generating properties because the thickness can be increased to the vicinity of the center of rotation of the oscillating weight, and the moment of inertia can be made greater.

### [2] Second Embodiment

In the first embodiment described above, assuming there is a plane perpendicular to the thickness direction of the timing device 10 (a surface perpendicular to the plane of paper), the generator unit 1A is disposed at a location in which the positive projection of the generator unit 1A on this plane does not overlap the positive projection of the piezoelectric actuator 41 on this plane.

In the second embodiment, the generator unit 1A is disposed at a location in which at least part of the positive projection of the generator on the aforementioned plane overlaps the positive projection of the piezoelectric actuator 41 in a plane perpendicular to the thickness direction of the timing device.

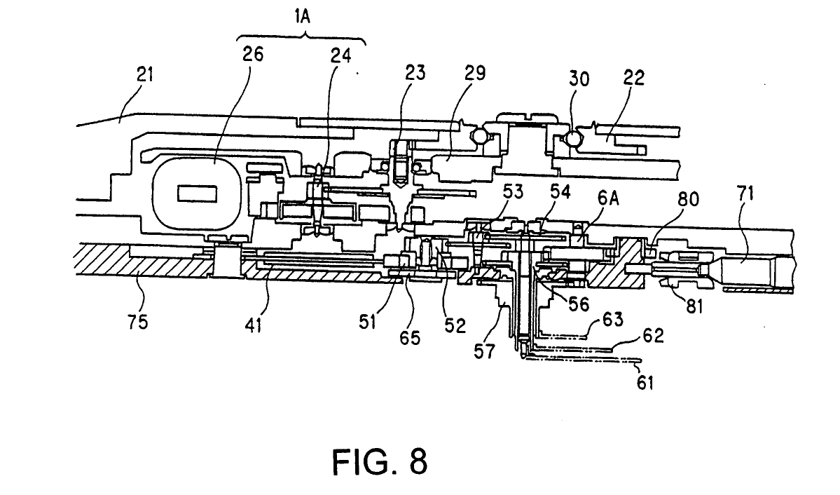

FIG. 8 is a cross-sectional view of part of the timing device of the second embodiment. In FIG. 8, the same sections are denoted by the same symbols as in FIGS. 2 and 3. Also in FIG. 8, the symbol 80 denotes a small iron wheel and the symbol 81 denotes a clutch wheel, and these members interlock with each other due to the operation of the setting stem 71, and are used to correct the time.

Assuming there is a plane perpendicular to the thickness direction, the generator unit 1A is disposed at a location in which at least part of the positive projection of the generator unit 1A on this plane overlaps the positive projection of the piezoelectric actuator 41 on this plane.

Such a configuration makes it possible to reduce the size of the timing device or other such drive device. Also, since the generator unit 1A and the piezoelectric actuator 41 are disposed to be partially overlapping, the capacity of the secondary battery 1C can be proportionately increased and the service life of the timing device or other such drive device can be extended. Furthermore, since the generator unit 1A and the piezoelectric actuator 41 can be disposed to be partially overlapping, the wiring distance of the entire circuit can be shortened and the drive device can be driven with reduced energy because the secondary battery 1C, the electronic circuit 2, and other such electric elements can be positioned adjacent both to the generator unit 1A and to the piezoelectric actuator 41. Additionally, since the generator unit 1A and the piezoelectric actuator 41 can be disposed to be overlapping, another piezoelectric actuator can be disposed in the open space and the drive device can have multiple functions.

Furthermore, electromagnetic noise resulting from the power generation of the electromagnetic generator has no effect because a piezoelectric actuator is used to drive the pointers, similar to the first embodiment. Therefore, the driving of the pointers does not stop and the displayed time is not slowed.

### [3] Third Embodiment

In the third embodiment, either the generator unit 1A or the piezoelectric actuator 41 is disposed on one side of the main plate, which is a structural member, while the other is disposed on the other side of the main plate.

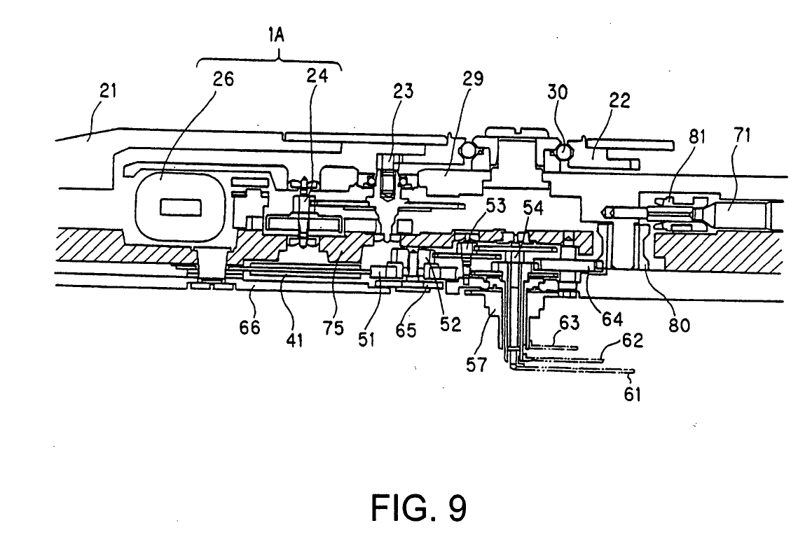

FIG. 9 shows a cross-sectional view of part of the timing device of the third embodiment. In FIG. 9, similar components are denoted by the same symbols as in FIG. 8.

FIG. 9 shows an example in which the generator unit 1A is disposed on the rear side (top side in FIG. 9) of the main plate 75, and the piezoelectric actuator 41 is disposed on the front side (bottom side in FIG. 9) of the main plate 75.

Assuming there is a plane perpendicular to the thickness direction of the timing device 10, such a configuration makes it possible to dispose the generator unit 1A and the piezoelectric actuator 41 at a location in which the positive projection of the generator unit 1A on this plane overlaps the positive projection of the piezoelectric actuator 41 on this plane, and to reduce the size of the timing device or other such drive device. Also, since the generator unit 1A and the piezoelectric actuator 41 can be disposed to be overlapping, the capacity of the secondary battery 1C can be increased and the service life of the timing device or other such drive device can be extended. Furthermore, since the generator unit 1A and the piezoelectric actuator 41 can be disposed to be overlapping, the wiring distance of the entire circuit can be shortened and the drive device can be driven with reduced energy because the secondary battery 1C, the electronic circuit 2, and other such electric elements can be positioned adjacent both to the generator unit 1A and to the piezoelectric actuator 41. Additionally, since the generator unit 1A and the piezoelectric actuator 41 can be disposed to be overlapping, another piezoelectric actuator can be disposed in the open space and the drive device can have multiple functions.

Furthermore, electromagnetic noise resulting from the power generation of the electromagnetic generator has no effect because a piezoelectric actuator is used to drive the pointers, similar to the second embodiment. Therefore, the driving of the pointers does not stop and the displayed time is not slowed.

### [4] Modification of the First Through Third Embodiments

The specific configuration of the piezoelectric actuator 41 was not described above, but specifically, the following aspects are possible.

First, a configuration based on the following shape is employed to improve the drive efficiency of the piezoelectric actuator 41. Specifically, the dimensions of the piezoelectric actuator 41 may be set as follows.

7 mm×2 mm×0.4 mm

Two PZT's (trademark) with a thickness of 0.15 mm are used as the piezoelectric elements, and a stainless steel plate with a thickness of 0.1 mm is used as the base plate.

Employing such an aspect ratio of approximately 7 mm×2 mm allows the resonance frequencies of the longitudinal oscillation and the curved secondary oscillation described above to be substantially equal, and makes efficient elliptical driving possible.

Also, the resonance frequency of the curved secondary oscillation in this case is preferably within a range of 0.97 to 1.03 times the resonance frequency of the longitudinal oscillation.

For example, the resonance frequency is specifically as follows.

Longitudinal oscillation: 284.3 kHz

Curved secondary oscillation: 288.6 kHz (1.015 times the resonance frequency of the longitudinal oscillation)

Satisfactory elliptical oscillation can be obtained in the piezoelectric actuator 41 by setting the resonance frequency as in this example.

However, the resonance frequency of the longitudinal oscillation and the resonance frequency of the curved secondary oscillation can be easily controlled by the aspect ratio of the piezoelectric actuator 41. In the example described above, the difference in resonance frequencies is reduced when the width is less than 2 mm at a fixed length (7 mm). The difference in resonance frequencies also increases when the width exceeds 2 mm.

Essentially, varying the width alone has no effect on the resonance frequency of the longitudinal oscillation, but causes variations solely in the resonance frequency of the curved secondary oscillation.

More specifically, it is clear that although the resonance frequencies vary with the Young's modulus of the piezoelectric elements or the reinforcing plate and must be optimized accordingly, the aspect ratio is preferably about 7:2. The resonance frequency of the curved secondary oscillation decreases with the mass of the contact section 41B of the piezoelectric actuator 41.

The setting of the optimal drive frequency will now be described.

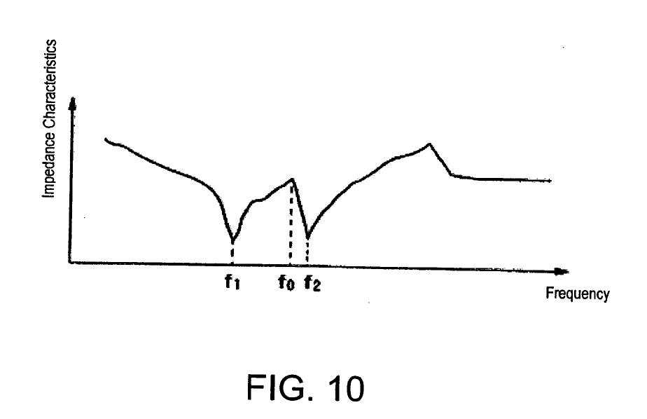

FIG. 10 is a diagram showing the frequency-impedance characteristics of a specific configuration of the piezoelectric actuator.

The frequency-impedance characteristics of the piezoelectric actuator 41 have an antiresonant frequency f₀ between the minimum value of the longitudinal oscillation (resonance frequency of the longitudinal oscillation) f₁ and the minimum value of the curved secondary oscillation (resonance frequency of the curved secondary oscillation) f₂.

In the example described above, the longitudinal oscillation resonance frequency f₁ is 284.3 kHz, and the curved secondary oscillation resonance frequency f₂ is 288.6 kHz. Therefore, it is possible to induce simultaneously longitudinal and curved secondary oscillations by setting the drive frequency (excitation frequency) of the piezoelectric actuator 41 at 280 kHz to 290 kHz.

In this case, a frequency between the longitudinal oscillation resonance frequency f₁ and the curved secondary oscillation resonance frequency f₂ is preferably set as the drive frequency of the piezoelectric actuator 41. In the example described above, the drive frequency of the piezoelectric actuator should be set as follows.

f₁=284.3 kHz≦drive-frequency≦f₂=288.6 kHz

More preferably, the drive-frequency of the piezoelectric actuator should be greater than the antiresonant frequency f₀ located between the longitudinal oscillation resonance frequency f₁ and the curved secondary oscillation resonance frequency f₂, and should be less than the curved secondary oscillation resonance frequency f₂.

Specifically, the following condition should be observed.

f₀<drive-frequency≦f₂

As a result, it is possible to obtain a greater elliptical oscillation (combination of longitudinal and curved secondary oscillations), and more efficient driving is also possible.

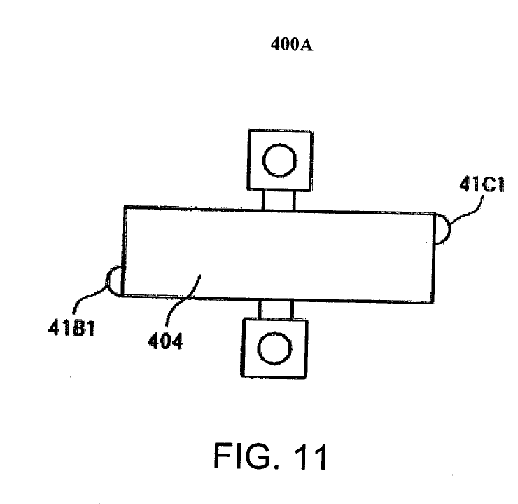

FIG. 11 is an explanatory diagram of an example of the electrode arrangement of a piezoelectric actuator.

The piezoelectric actuator 400A of the present modification is provided solely with a full electrode 404, as shown in FIG. 11.

A mechanically unbalanced state is created, and longitudinal and curved secondary oscillations are created by providing the piezoelectric actuator 41 with a balance section 41C1 and a contact section 41B1 in an unbalanced location instead of providing the piezoelectric actuator 41, which is an oscillator, with a contact section 41B.

In the present modification, a contact section 41B1 and a balance section 41C1 are provided as contact sections, but the contact section 41B1 alone may also be provided.

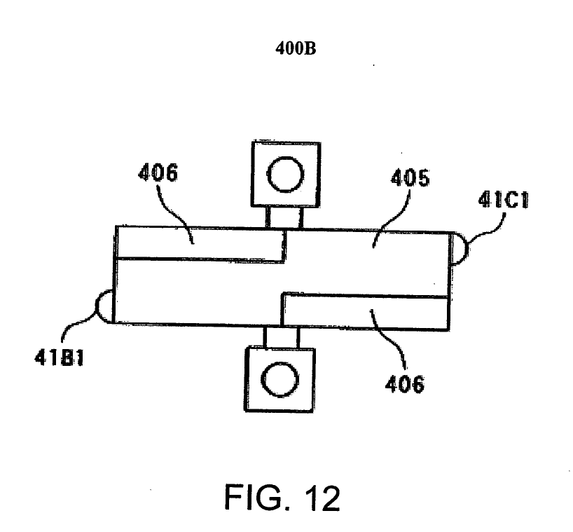

FIG. 12 is an explanatory diagram of the electrode arrangement for another piezoelectric actuator.

The modification in FIG. 11 was configured with a full electrode 404, but the piezoelectric actuator 400B of the present embodiment can be configured with a drive electrode 405 and detection electrodes 406 disposed at a location in which the contact section 41B1 and balance section 41C1 are joined to each other, as shown in FIG. 11.

When such a configuration is employed, the longitudinal oscillation of the piezoelectric elements is vibrated by the application of a drive voltage to the drive electrode 405, and an imbalance is created in the expansion and contraction of the piezoelectric elements. Furthermore, the curved secondary oscillation is reliably vibrated by the mechanically unbalanced state brought about by the contact section 41B1 and the balance section 41C1.

The longitudinal and curved secondary oscillations are then combined to create elliptical oscillation.

More accurate control is possible if the detection electrodes 406 are used to detect the oscillation state for the same reasons as in the modification described above.

The rotor was driven in one direction in the above description, but a configuration may also be adopted such that the rotor is driven both forwards and backwards.

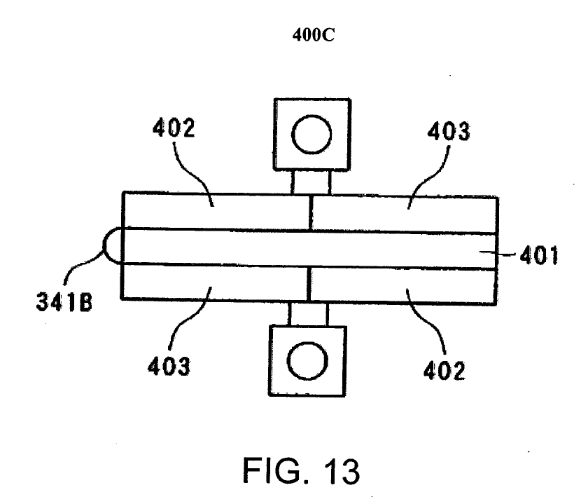

FIG. 13 is an explanatory diagram of the arrangement of electrodes in a piezoelectric actuator driven both forwards and backwards.

The electrode arrangement in the piezoelectric actuator 400C of the present modification is configured so as to include a middle electrode 401 and two electrode pairs 402 and 403 disposed so as to intersect with the middle electrode 401.

With such a configuration, the middle electrode 401 and the electrode pair 402 are driven by the application of a drive voltage in order to achieve elliptical driving in a first direction (forward). A drive voltage is not applied to the electrode pair 403.

As a result, the middle electrode 401 vibrates longitudinal oscillation, but an imbalance is created in the expansion and contraction of the longitudinal oscillation of the piezoelectric elements by applying a drive voltage solely to the electrode pair 402, and curved secondary oscillation in the first direction is vibrated.

The longitudinal oscillation and the curved secondary oscillation are then combined to create elliptical oscillation of the in the first direction.

The middle electrode 401 and the electrode pair 403 are driven by the application of a drive voltage in order to create an elliptical drive in the contact section 341B in a second direction (backwards). A drive voltage is not applied to the electrode pair 402.

As a result, longitudinal oscillation is vibrated by the middle electrode 401, but the expansion and contraction originating in the longitudinal oscillation of the piezoelectric elements is rendered unbalanced by applying a drive voltage solely to the electrode pair 403 out of the electrode pairs 402 and 403, and curved secondary oscillation in the second direction is vibrated.

The longitudinal oscillation and the curved secondary oscillation are then combined to create elliptical oscillation in the second direction.

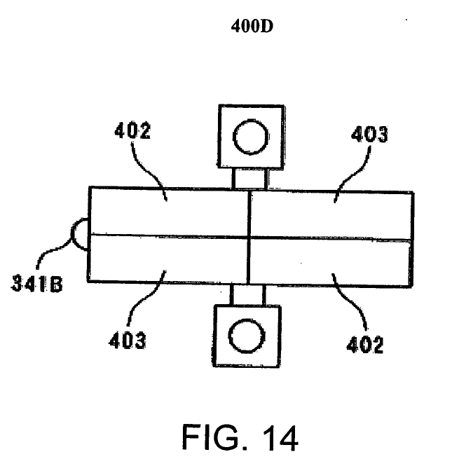

FIG. 14 is an explanatory diagram of another arrangement of electrodes in a piezoelectric actuator driven both forwards and backwards.

A middle electrode 401 and two electrode pairs 402 and 403 were provided in the modifications described above, but in the piezoelectric actuator 400D of the present modification, the middle electrode 401 is dispensed with and only the two electrode pairs 402 and 403 are provided as shown in FIG. 14.

With such a configuration, the electrode pair 402 is driven by the application of a drive voltage in order to drive elliptically the contact section 341B in the first direction (forward). A drive voltage is not applied to the electrode pair 403.

As a result, longitudinal oscillation of the piezoelectric elements is vibrated by the application of a drive voltage to the electrode pair 402, the expansion and contraction of the piezoelectric elements are rendered unbalanced, and curved secondary oscillation in the first direction is vibrated.

The longitudinal oscillation and the curved secondary oscillation are then combined to create elliptical oscillation in the first direction.

The electrode pair 403 is driven by the application of a drive voltage in order to drive elliptically the contact section 341B in the second direction (backwards). A drive voltage is not applied to the electrode pair 402.

As a result, longitudinal oscillation of the piezoelectric elements is vibrated by the application of a drive voltage to the electrode pair 403, the expansion and contraction of the piezoelectric elements are rendered unbalanced, and curved secondary oscillation in the second direction is vibrated.

The longitudinal oscillation and the curved secondary oscillation are then combined to create elliptical oscillation in the second direction.

In these cases, the electrodes to which a drive voltage is not applied are preferably used as detection electrodes to detect the oscillation state for the same reasons as in the modifications described above.

The location at which the piezoelectric actuator is supported was not described in detail above, but it is possible to reduce oscillation loss by supporting the middle section, which is the oscillation node of both the longitudinal oscillation and the curved secondary oscillation.

The application of a drive device to a timing device was described above, but this approach is also applicable to a drive device for a mechanisms other than a time information display; for example, a mechanical structure such as one that moves the arm of a mechanical doll. The drive device may also be used in analog display devices that use pointers to display temperature, air pressure, and other such physical quantities in addition to time information.

Effects of First Through Third Embodiments

According to the first through third embodiments as described above, in a timing device wherein a power generator utilizes electromagnetic induction to convert kinetic energy into electric energy, a piezoelectric actuator is used as a drive source for the time display unit, so the time display unit is not affected by the power generating operation of the power generator and the time can be accurately displayed.

### [4] Fourth Embodiment

The fourth embodiment will now be described.

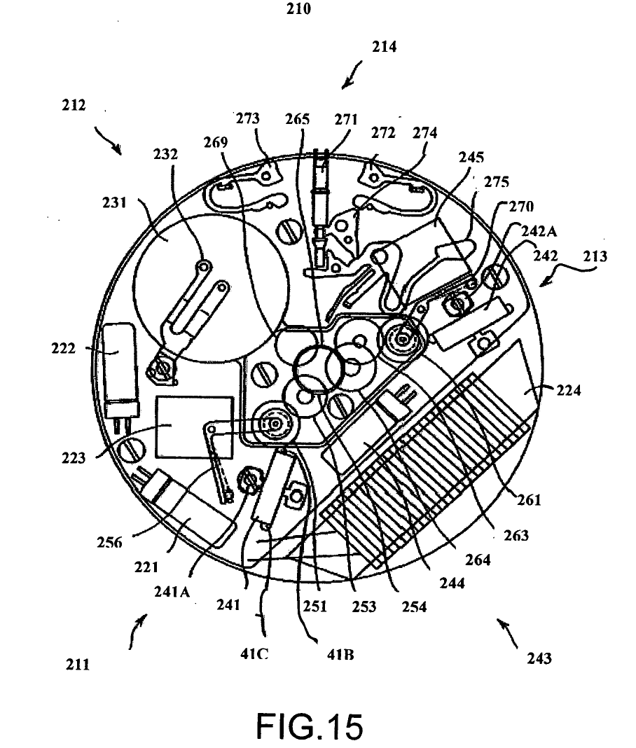

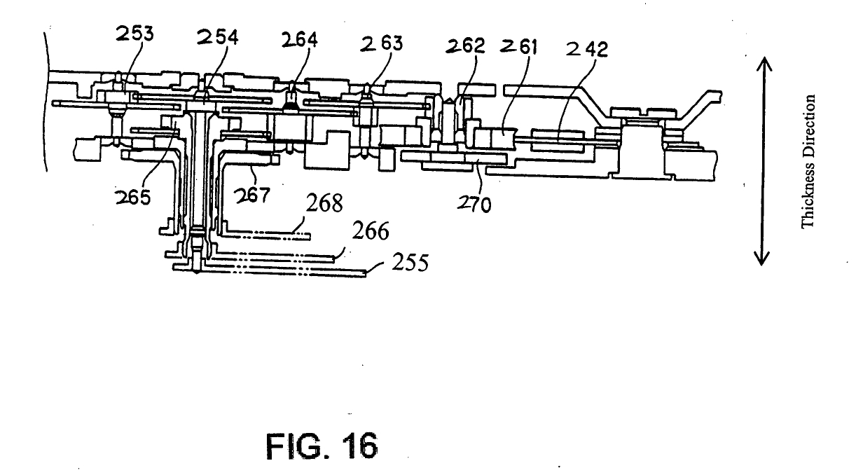

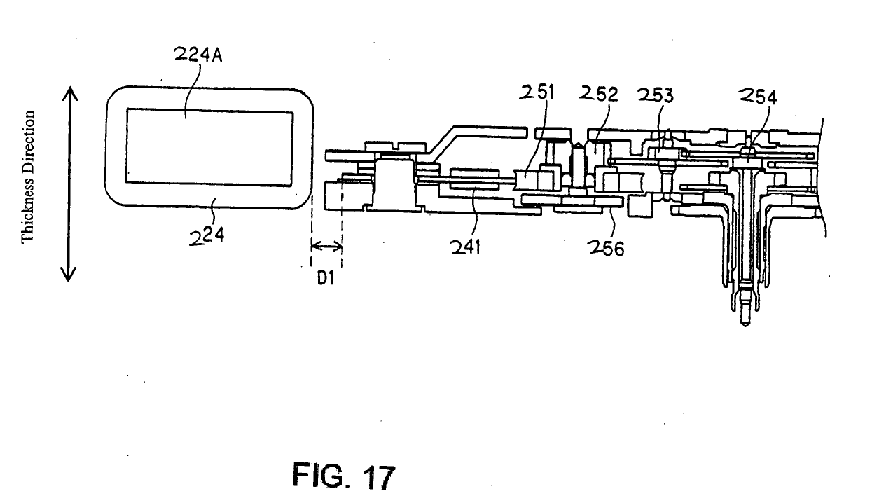

FIG. 15 is a partial plan view of the timing device relating to the fourth embodiment. FIG. 16 is a cross-sectional view of one part of the timing device relating to the fourth embodiment. FIG. 17 is a cross-sectional view of another part of the timing device relating to the fourth embodiment.

The timing device 210 is a wristwatch designed for use by wrapping a belt coupled with the main body of the device around the wrist of the user.

In general terms, the timing device 210 includes a receiving circuit (communication means) 211, an electric power source 212, a timing unit (time display means) 213, and an operating unit 214.

The receiving circuit 211 includes a first receiving crystal oscillator 221 for creating a first standard oscillation signal, a second receiving crystal oscillator 222 for creating a second standard oscillation signal, a receiving processor IC 223 for performing reception processing on the basis of the first standard oscillation signal and the second standard oscillation signal, and a coil antenna 224 for receiving externally transmitted electromagnetic waves.

The electric power source 212 includes a battery 231 for supplying a source of electricity, and a battery terminal 232 for electrically connecting the battery 231 and the base plate.

In general terms, the timing unit 213 includes a second driving piezoelectric actuator 241 for driving a second hand as a pointer component, an hour/minute driving piezoelectric actuator 242 for driving an hour and minute hand as pointer components, a gear train section 243 for transmitting the driving force for driving the pointers, a standard oscillation signal crystal oscillator 244 for keeping time, and a timing IC 245 for performing various timing processes on the basis of the standard oscillation signals for timing.

The gear train section 243 is similar to a regular analog timepiece and includes a second rotor 251, a second rotor pinion 252, a second intermediate wheel 253, a second wheel 254, a second hand 255, and a second rotor pressure member 256. Furthermore, the gear train section 243 also includes an hour/minute rotor 261, an hour/minute rotor pinion 262, a first hour/minute intermediate wheel 263, a second hour minute intermediate wheel 264, a center wheel and pinion 265, a minute hand 266, an hour wheel 267, an hour hand 268, a minute wheel 269, and a rotor pressure section 270.

The operating unit 214 includes a setting stem 271, a first switch 272, a second witch 273, a setting lever 274, and a yoke 275, and is designed to be able to perform various settings including time setting and time correction, similar to common timing devices.

The relative arrangement of the coil antenna and the second driving piezoelectric actuator will now be described with reference to FIGS. 16 and 17.

In the fourth embodiment, assuming there is a plane perpendicular to the timing device 210, the coil antenna 224 is disposed at a location in which the positive projection of the antenna on this plane does not overlap the positive projection of the second driving piezoelectric actuator 241 and the hour/minute driving piezoelectric actuator 242 on this plane, and is also disposed to form a space D1 with a specific distance (FIG. 17) in a direction perpendicular to the thickness direction.

Such an arrangement makes it possible to configure a thin wristwatch wherein the thickness of the timing device 210 can be reduced.

In this case, the configuration of the second driving piezoelectric actuator and the hour/minute driving piezoelectric actuator is similar to those shown in FIGS. 4 through 7 and FIGS. 11 through 14, so detailed descriptions are omitted.

The operation of the second driving piezoelectric actuator 241 will now be described.

When an alternating-current drive signal is applied to the piezoelectric elements 113 and 114 from the drive circuit 200 via the electrodes 113A and 114A, oscillation that expands and contracts in the longitudinal direction is created in the piezoelectric elements 113 and 114. In this case, the piezoelectric elements 113 and 114 create longitudinal oscillation that expands and contracts in the longitudinal direction, as shown by the arrow in FIG. 5. When the second driving piezoelectric actuator 241 is electrically vibrated by the longitudinal oscillation due to the application of a drive signal to the piezoelectric elements 113 and 114, an angular momentum is created about the center of gravity of the second driving piezoelectric actuator 241 by the unbalanced weight of the second driving piezoelectric actuator 241. This angular momentum induces curved secondary oscillation whereby the second driving piezoelectric actuator 241 swings in the width direction, as shown in FIG. 6. At this point a greater degree of curved oscillation can be induced to create a greater angular momentum by disposing the contact section 41B on the tip of the second driving piezoelectric actuator 241 opposite from the balance section 41C.

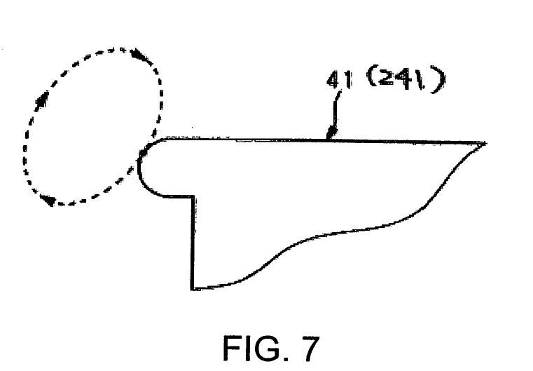

Longitudinal oscillation and curved secondary oscillation are thus created in the second driving piezoelectric actuator 241, and the longitudinal oscillation and curved secondary oscillation are combined. The area at which the contact section 41B of the second driving piezoelectric actuator 241 and the second rotor 251 come in contact thereby moves along an elliptic path, as shown in FIG. 7. As a result of the movement of the contact section 41B along an elliptic path in the direction of the timepiece, the force of the contact section 41B pushing on the second rotor 251 increases when the contact section 41B is in a position expanded toward the second rotor 251. Conversely, the force of the contact section 41B pushing on the second rotor 251 decreases when the contact section 41B is expanded to a position distanced from the second rotor 251.

Therefore, the second rotor 251 is rotatably driven in the direction of displacement of the contact section 41B while both types of pressure are large, or, in other words, when the contact section 41B is in a position expanded toward the second rotor 251.

As described above, the second driving piezoelectric actuator 241 rotatably drives the second rotor 251 by elliptical movement due to both the longitudinal oscillation and the curved oscillation. At this point, the second rotor 251 is pressed against the contact section of a second drive actuator by a second rotor pressure member 256. The second rotor 251 is therefore rotatably driven in a reliable manner.

The rotational driving of the second rotor 251 causes the second rotor pinion 252 to rotate. The second intermediate wheel 253 interlocking with the second rotor pinion 252 is then rotatably driven.

Furthermore, the second intermediate wheel 253 interlocks with the second wheel 254, causing the second hand 255 fixed to the second wheel 254 to move.

Also, the hour/minute driving piezoelectric actuator 242 rotatably drives the hour/minute rotor 261 by elliptical movement that results from a combination of longitudinal and curved oscillations. At this point, the hour/minute rotor 261 is pressed against the contact section of an hour/minute drive actuator by an hour/minute rotor pressure member 270. The hour/minute rotor 261 is therefore rotatably driven in a reliable manner.

The rotational driving of the hour/minute rotor 261 causes the hour/minute rotor pinion 262 to rotate. The first hour/minute intermediate wheel 263 interlocking with the second hour/minute rotor pinion 262 is then rotatably driven.

Furthermore, the first hour/minute intermediate wheel 263 interlocks with the second hour minute intermediate wheel 264, causing the second hour minute intermediate wheel 264 to be rotatably driven.

The second hour minute intermediate wheel 264 interlocks with the center wheel and pinion 265 and with the minute wheel 269 via the center wheel and pinion 265, and induces movement in the minute hand 266 fixed to the center wheel and pinion 265 and the hour hand 268 fixed to the hour wheel 267.

The operation of the receiving circuit will now be described.

In Japan, the first receiving crystal oscillator 221 of the receiving circuit 211 creates a first standard oscillation signal corresponding to a 40-kHz LF standard wave, and outputs the signal to the receiving processor IC 223. Similarly, the second receiving crystal oscillator 222 creates a second standard oscillation signal corresponding to a 60-kHz LF standard wave, and outputs the signal to the receiving processor IC 223.

In addition, the coil antenna 224, configured as a ferrite antenna, for example, receives an LF standard wave on which time data are superposed.

The receiving processor IC 223 demodulates the LF standard wave received by the coil antenna 224 as time data, stores the time data, and transmits the data to the timing IC.

The receiving processor IC 223 is configured to include an AGC (Automatic Gain Control) circuit, an amplification circuit, a band-pass filter, a demodulation circuit, and a decoding circuit, all not shown.

The amplification circuit of the receiving processor IC 223 amplifies the LF standard wave signal received by the coil antenna 224 under the gain control of the AGC circuit, and outputs the result to the band-pass filter.

The band-pass filter extracts only specific frequency components from the amplified LF standard wave signal and outputs the result to the demodulation circuit.

The demodulation circuit smoothes the inputted specific frequency components of the LF standard wave signal, demodulates the result, and outputs it to the decoding circuit.

The decoding circuit decodes the demodulated LF standard wave signal, and outputs the result as a reception output signal.

At this point, the AGC circuit controls the gain of the amplification circuit on the basis of the output signal of the demodulation circuit, and performs this control so that the reception level of the LF standard wave signal remains constant.

At this point, a power save mode signal, which is a signal for exerting control to reduce power consumption, is supplied from the timing IC 245, and the receiving processor IC 223 ceases to function when operation is not necessary.

Normally, the receiving processor IC 223 is controlled by the power save mode signal so as to perform reception about once a day. The receiving operation is normally repeated many times when the time data cannot be received.

Electromagnetic noise is not generated in the fourth embodiment and does not affect the reception of the LF standard waves because a piezoelectric actuator is used to drive the pointers. Therefore, the receiving operation of the receiving circuit 211 can be performed in conjunction with the pointer driving operation of the timing unit 213.

Therefore, according to the fourth embodiment, LF standard waves can be received anytime and the time can be corrected. Furthermore, there is no need to provide a control procedure or circuit to stop driving the pointers during the receiving operation, and the control and circuit configuration can be simplified.

### [5] Fifth Embodiment

In the fourth embodiment, assuming there is a plane perpendicular to the thickness direction of the timing device 210 (a surface perpendicular to the plane of paper), the coil antenna 224 is disposed at a location in which the positive projection of the antenna on this plane does not overlap the positive projection of the second driving piezoelectric actuator 241 on this plane, and is also disposed to form a space with a specific distance in a direction perpendicular to the thickness direction.

Accordingly, in the fifth embodiment, the coil antenna is disposed at a location in which at least part of the positive projection of the antenna on a plane perpendicular to the thickness direction of the timing device overlaps the positive projection of either the second driving piezoelectric actuator or the hour/minute driving piezoelectric actuator on the plane, and is also disposed to form a space with a specific distance in the thickness direction.

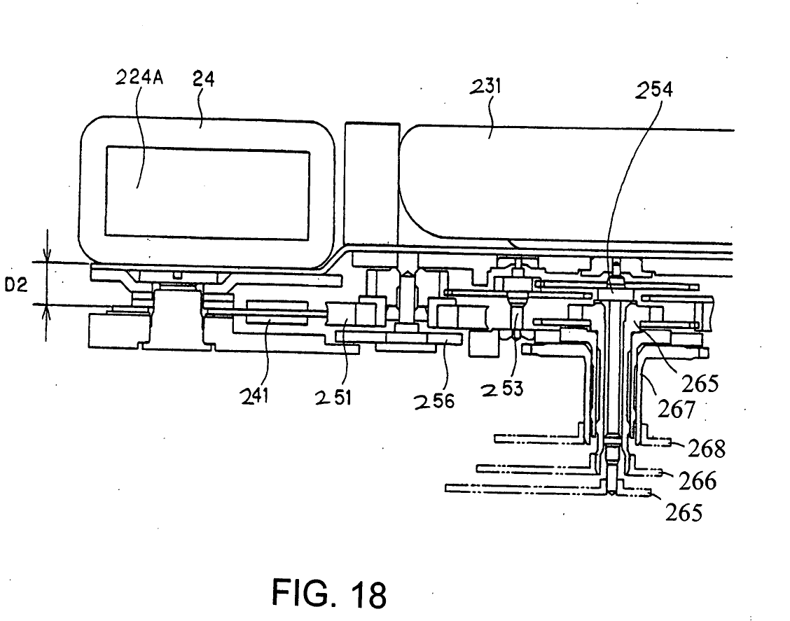

FIG. 18 shows a cross-sectional view of part of the timing device of the fifth embodiment. The components in FIG. 18 similar to those in FIG. 16 or 17 are denoted by the same symbols.

Assuming there is a plane perpendicular to the thickness direction, the coil antenna 224 is disposed at a location in which at least part of the positive projection of the coil antenna 224 on this plane overlaps the positive projection of the second driving piezoelectric actuator 241 on this plane, and is also disposed to form a space with a specific distance D2 in the thickness direction.

It is possible to reduce the size of the timing device with such a configuration.

Furthermore, LF standard waves can be received anytime to correct the time, similar to the fourth embodiment. Moreover, there is no need for a control procedure or circuit to stop driving the pointers during the receiving operation, and the control and circuit configuration can be simplified.

Modification of the Fourth and Fifth Embodiments

The case of using a receiving device for receiving LF standard waves as a communication unit was described above, but it is also possible to use a wireless communication device for both reception and transmission.

Also, the case of including a second driving piezoelectric actuator and a hour/minute driving piezoelectric actuator was described in all the embodiments described above, but it is also possible to use a configuration wherein three piezoelectric actuators are provided for separately driving the second hand, the minute hand, and the hour hand, or one piezoelectric actuator is provided for driving the second hand, the minute hand, and the hour hands.

Also, a ferrite antenna is used as an antenna for receiving LF standard waves on which time information is superposed in the embodiments described above, but either a loop antenna or a ferrite antenna may be used when FM multiplex broadcasting (76 MHz to 108 MHz) on which time information is superposed is received, and either a microstrip antenna or a helical antenna may be used when electromagnetic waves (1.5 GHz) on which time information is superposed are received from a GPS satellite.

Also, in the fourth and fifth embodiments described above, the time information for the hours, minutes, and second is automatically corrected based on LF standard waves on which time information is superposed, but this process is not limited to the time display for hours, minutes, and second, and may include the automatic correction of a date display. Since date information is included in the LF standard waves as described above, the date display can be automatically corrected based on the LF standard waves when a piezoelectric actuator for driving a calendar display is included in addition to the piezoelectric actuator for driving the hour/minute/second display. In this case, an element for detecting the calendar display position may be added.

Also, a configuration wherein LF standard waves were received as electromagnetic waves on which time information is superposed was used in the fourth and fifth embodiments described above, but it is also possible to use a configuration wherein a GPS signal, a pager signal in a FLEX-TD format, an FM multiplex signal, a CDMA signal, or other such various signals are used instead of LF standard waves.

According to the fourth and fifth embodiments described above, the communication process performed by the communication unit with the external communication device via the antenna is not affected, and can be performed in conjunction with the time display operation and the communication operation, because a piezoelectric actuator is used as the drive source for the time display unit.

Thus, there is no need for a control procedure or circuit to stop the time display operation during the communication operation, and the control and the circuit configuration can be simplified.

The terms “front,” “back, “up,” “down,” “perpendicular,” “horizontal,” “slanted,” and other direction-related terms used above indicate the directions in the diagrams used herein. Therefore, the direction-related terms used to describe the present invention should be interpreted in relative terms as applied to the diagrams used herein.

“Substantially,” “essentially,” “about,” and other terms used above that represent an approximation indicate a reasonable amount of deviation that does not bring about a considerable change as a result. Terms that represent these approximations should be interpreted so as to include an error of about ±5% at least, as long as there is no considerable change due to the deviation.

The embodiments described above constitute one part of the embodiments of the present invention, and it is apparent to those skilled in the art that it is possible to add modifications to the above-described embodiments by using the above-described disclosure without exceeding the range of the present invention as defined in the claims. The above-described embodiments furthermore do not limit the range of the present invention, which is defined by the accompanying claims or equivalents thereof, and are only designed to provide a description of the present invention.

What is claimed is:

1. A drive device, comprising:
a generator unit provided with a generating coil and designed to convert kinetic energy into electric energy by utilizing electromagnetic induction;
a storage unit to store the electric energy; and
a drive unit having a piezoelectric actuator to which the electric energy from the storage unit is supplied, and a mechanical structure driven by the piezoelectric actuator.

2. The drive device according to claim 1, wherein the mechanical structure includes an analog display device having analog pointers for displaying physical quantities.

3. A drive device, comprising:
generating means for converting kinetic energy into electric energy by utilizing electromagnetic induction;
storage means for storing the electric energy; and
drive means having a piezoelectric actuator to which the electric energy from the storage means is supplied, and a mechanical structure driven by the piezoelectric actuator.

4. The drive device according to claim 3, wherein the drive means further comprises time display means driven by the piezoelectric actuator and designed for displaying the time.
